(19) United States
(12) Patent Application Publication
(10) Pub. No.: US 2019/0354188 A1
(43) Pub. Date: Nov. 21, 2019

(54) OPTICAL DEVICE

(71) Applicant: PANASONIC INTELLECTUAL PROPERTY MANAGEMENT CO., LTD., Osaka (JP)

(72) Inventors: Masaaki OCHI, Osaka (JP); Yu MOROOKA, Osaka (JP)

(21) Appl. No.: 16/530,859

(22) Filed: Aug. 2, 2019

Related U.S. Application Data
(63) Continuation of application No. PCT/JP2018/005211, filed on Feb. 15, 2018.

(30) Foreign Application Priority Data
Feb. 23, 2017 (JP) 2017-032559

(51) Int. Cl. G06F 3/01; H04N 5/232

(52) U.S. Cl. CPC G06F 3/016; H04N 5/23287; H04N 5/23299; H04N 5/23203; H04N 5/23258

(57) ABSTRACT

A camera device includes a camera unit, a movable unit, a fixed unit, a driving unit, a driving control unit, and a detection unit. The driving control unit controls the driving unit to drive the movable unit in rotation. The detection unit detects a predetermined type of operation performed by the user on at least one of the fixed unit or the movable unit. The driving control unit controls, when the detection unit detects the predetermined type of operation performed by the user, the driving unit such that the movable unit produces vibrations.

### CROSS-REFERENCE TO RELATED APPLICATIONS

This application is a U.S. continuation of International Patent Application No. PCT/JP2018/005211, filed on Feb. 15, 2018, which in turn claims the benefit of priority to Japanese Patent Application No. 2017-032559, filed on Feb. 23, 2017, the entire disclosures of which are hereby incorporated by reference.

### TECHNICAL FIELD

The present disclosure generally relates to an optical device, and more particularly relates to an optical device configured to drive an object to be driven in rotation.

### BACKGROUND ART

Various alternative techniques for controlling a camera, such as a technique for entering any desired command into the camera by producing vibrations in the camera instead of pressing its button, have been proposed in the art.

JP 2012-146156 A teaches preventing the camera from being operated erroneously by distinguishing the operation of intentionally producing vibrations in the camera (such as a tap operation of lightly tapping the camera's housing) from other kinds of vibrations not intended by the user (such as vibration produced when the camera is put on a desk).

Meanwhile, as wearable cameras have become increasingly popular these days, the user more and more often has opportunities to wear such a wearable camera on him- or herself to shoot an environment surrounding him or her while exercising or riding a bicycle, for example.

It is not easy for the user, who is wearing a wearable camera (an exemplary optical device) such as a helmet with a wearable camera, to make shooting-related button pressing of the wearable camera, because the button is out of sight for him or her in such a situation. Therefore, such button pressing could be replaced with the technique disclosed in JP 2012-146156 A for the wearable camera. Nevertheless, if the user who is wearing a wearable camera cannot see the wearable camera with his or her own eyes, then he or she is not sure, while wearing the wearable camera, if his or her command entered through a tap operation has been certainly accepted.

### SUMMARY

The present disclosure provides an optical device that notifies, even in such a situation where it is not easy for the user to confirm the optical device's operation with his or her own eyes, the user that his or her command has been certainly accepted.

An optical device according to an aspect of the present disclosure includes an optical unit, a movable unit, a fixed unit, a driving unit, a driving control unit, and a detection unit. The optical unit includes an optical element. The movable unit holds the optical unit thereon. The fixed unit supports the movable unit so as to make the movable unit rotatable in at least two directions selected from the group consisting of a panning direction, a tilting direction, and a rolling direction. The driving unit drives the movable unit in rotation in the at least two directions with respect to the fixed unit. The driving control unit controls the driving unit to rotate the movable unit. The detection unit detects a predetermined type of operation performed by a user on at least one of the fixed unit or the movable unit. The driving control unit controls, when the detection unit detects the predetermined type of operation performed by the user, the driving unit such that the movable unit produces vibrations in at least one direction out of the at least two directions.

### BRIEF DESCRIPTION OF DRAWINGS

FIG. 1 is a block diagram illustrating a configuration for a camera device (optical device) according to an embodiment of the present disclosure;

FIG. 2A is a perspective view of the camera device;

FIG. 2B is a plan view of the camera device;

FIG. 3 is a cross-sectional view taken along the plane X-X of the camera device;

FIG. 4 is an exploded perspective view of the camera device;

FIG. 5 is an exploded perspective view of a movable unit included in the camera device; and

FIG. 6 is a block diagram illustrating a configuration for a telecommunications device according to an embodiment of the present disclosure.

### DESCRIPTION OF EMBODIMENTS

Note that embodiments and their variations to be described below are only examples of the present disclosure and should not be construed as limiting. Rather, those embodiments and variations may be readily modified in various manners depending on a design choice or any other factor without departing from a true spirit and scope of the present disclosure.

### Embodiments

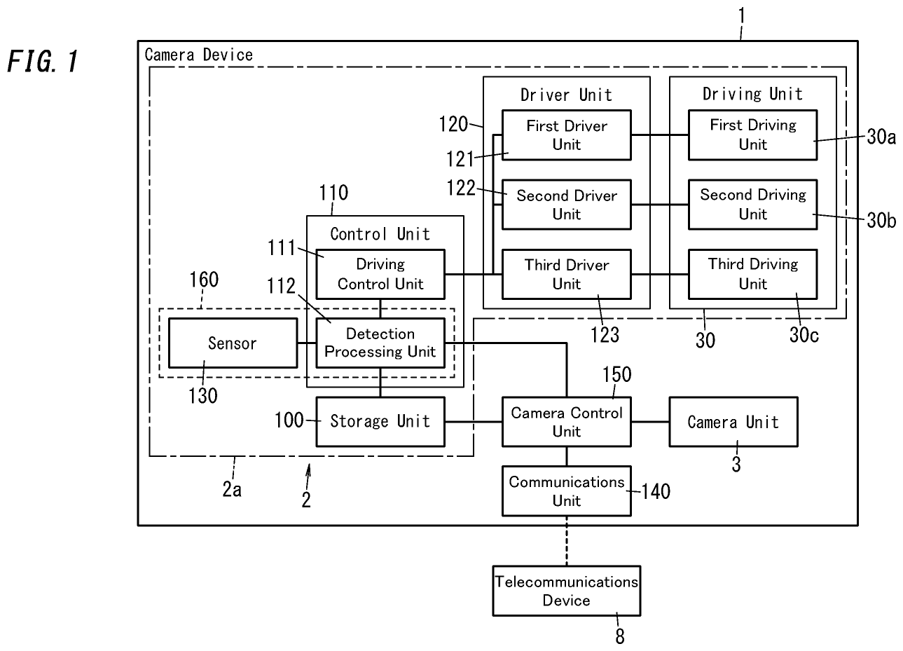

A camera device 1 as an exemplary optical device according to this embodiment will be described with reference to FIGS. 1-5.

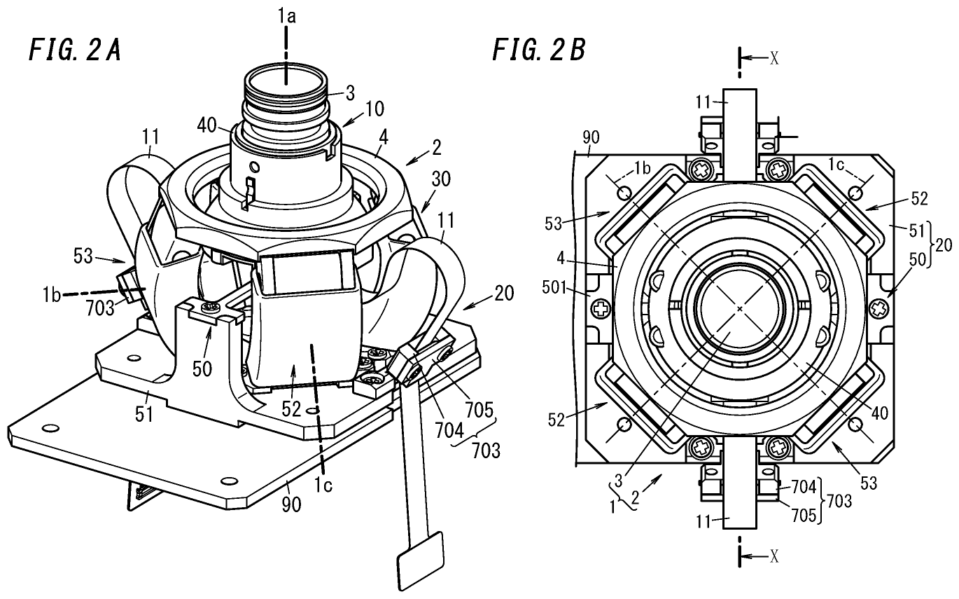

The camera driver 1 may be a portable camera, for example, and includes an actuator 2 and a camera unit 3 as shown in FIGS. 2A-4. The camera unit 3 is rotatable in tilting, panning, and rolling directions. The actuator 2 serves as a stabilizer 2a for driving the camera unit 3 in any desired rotational direction with unnecessary vibrations of the camera unit 3 reduced.

When subjected to a predetermined type of operation (such as a tap operation) by the user, the camera device 1 performs the camera unit's 3 shooting-related function according to the number of times of the tap operation performed (i.e., the number of times of taps). For example, the camera device 1 makes the camera unit 3 start or stop capturing a moving picture according to the number of times of taps. As used herein, the “tap operation” refers to the operation of lightly tapping the camera device 1. When the camera device 1 is lightly tapped once, the count of the tap operation increases by one.

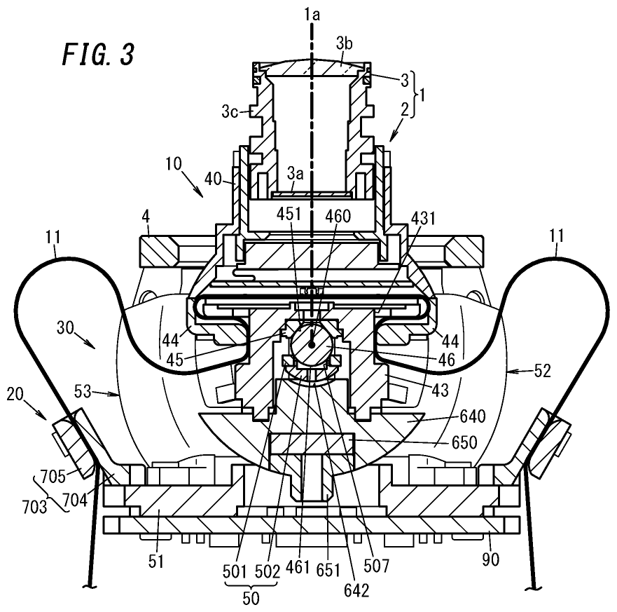

The camera unit 3 includes an image sensor 3a, a lens 3b for forming a subject image on the image capturing plane of the image sensor 3a, and a lens barrel 3c for holding the lens 3b (see FIG. 3). The camera unit 3 converts video produced on the image capturing plane of the image sensor 3a into an electrical signal. The lens barrel 3c protrudes along the optical axis 1a of the camera unit 3. The lens barrel 3c has a circular cross section when taken perpendicularly to the optical axis 1a. Also, a plurality of cables to transmit the electrical signal generated by the image sensor 3a to an external image processor circuit (as an exemplary external circuit) are electrically connected to the camera unit 3 via connectors. In this embodiment, the plurality of cables includes coplanar waveguides or micro-strip lines. Alternatively, the plurality of cables may include fine-line coaxial cables each having the same length. Those cables are grouped into a predetermined number of bundles of cables 11.

The actuator 2 (camera device 1) includes an upper ring 4, a movable unit 10, a fixed unit 20, a driving unit 30, and a printed circuit board 90 as shown in FIGS. 2A and 3.

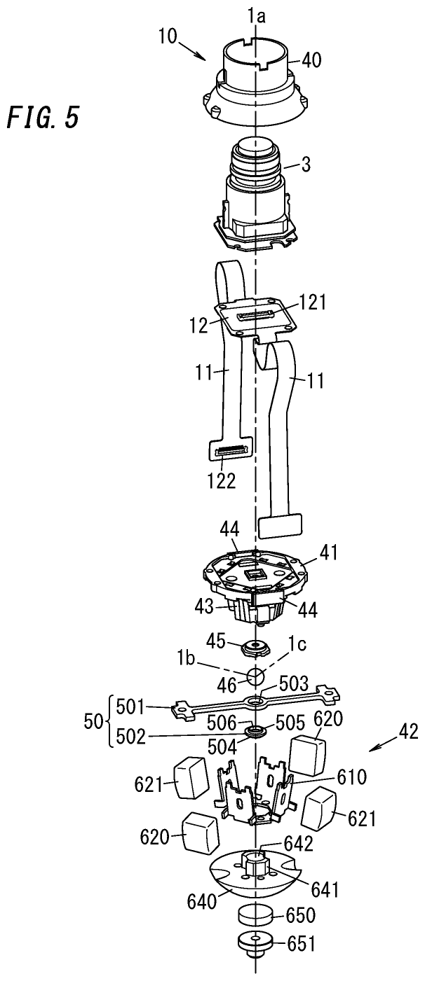

The movable unit 10 includes a camera holder 40, a first movable base 41, and a second movable base 42 (see FIG. 5). The movable unit 10 is fitted into the fixed unit 20 with some gap left between the movable unit 10 and the fixed unit 20. The movable unit 10 rotates (i.e., rolls) around the optical axis 1a of the lens of the camera unit 3 with respect to the fixed unit 20. The movable unit 10 also rotates around an axis 1b and an axis 1c, which are both perpendicular to the optical axis 1a, with respect to the fixed unit 20. In this case, the axis 1b and the axis 1c are both perpendicular to a fitting direction, in which the movable unit 10 is fitted into the fixed unit 20 while the movable unit 10 is not rotating. Furthermore, these axes 1b and 1c intersect with each other at right angles. A detailed configuration for the movable unit 10 will be described later. The camera unit 3 has been mounted on the camera holder 40. The configuration of the first movable base 41 and the second movable base 42 will be described later. Rotating the movable unit 10 allows the camera unit 3 to rotate. In this embodiment, when the optical axis 1a is perpendicular to both of the axes 1b and 1c, the movable unit 10 (i.e., the camera unit 3) is defined to be in a neutral position. In the following description, the direction in which the movable unit 10 (camera unit 3) rotates around the axis 1b is defined herein to be a “panning direction” and the direction in which the movable unit 10 (camera unit 3) rotates around the axis 1c is defined herein to be a “tilting direction.” Furthermore, the direction in which the movable unit 10 (camera unit 3) rotates (rolls) around the optical axis 1a is defined herein to be a “rolling direction.” Note that all of the optical axis 1a and the axes 1b and 1c are virtual axes.

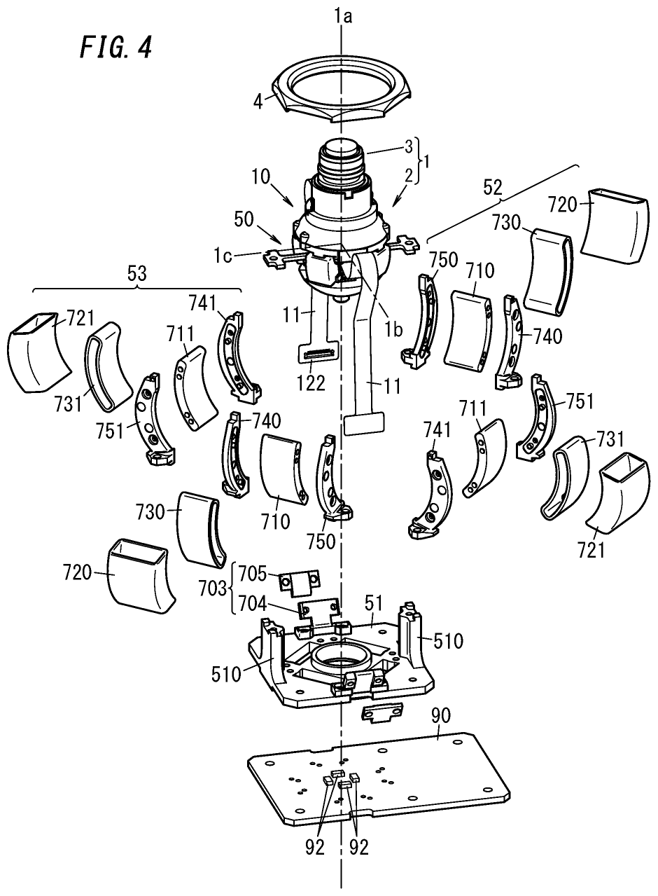

The fixed unit 20 includes a coupling member 50 and a body 51 (see FIG. 4).

The coupling member 50 includes a linear coupling bar 501 and a loosely fitting member 502. The coupling bar 501 has an opening 503 cut through a middle portion thereof. The loosely fitting member 502 includes a base 504 and a wall 505. When viewed along the optical axis 1a of the camera unit 3 in the neutral position, the base 504 has a circular shape. One surface, closer to the camera unit 3, of the base 504 is a flat surface, while the other surface, more distant from the camera unit 3, of the base 504 is a spherical surface. The wall 505 is provided around the center of the flat surface of the base 504 and has a recess 506 (see FIG. 5). The diameter of the outer periphery of the wall 505 is approximately equal to the diameter of the opening 503 of the coupling bar 501. The wall 505 is fitted into the opening 503 of the coupling bar 501.

The body 51 includes a pair of protrusions 510. The pair of protrusions 510 are provided so as to face each other in a direction perpendicular to the optical axis 1a of the movable unit 10 in the neutral position. The pair of protrusions 510 is also provided to be located in the gaps between the first coil units 52 and second coil units 53 arranged (to be described later). The coupling member 50 is screwed onto the body 51 with the second movable base 42 interposed between itself and the body 51. Specifically, both ends of the coupling member 50 are respectively screwed onto the pair of protrusions 510 of the body 51.

The body 51 is provided with two fixing portions 703 for fixing the two bundles of cables 11 thereto (see FIGS. 2A and 3). The two fixing portions 703 are arranged to face each other perpendicularly to the direction in which the pair of protrusions 510 is arranged. The two fixing portions 703 are provided for the body 51 so as to tilt toward the camera unit 3 with respect to a plane including the axes 1b and 1c (see FIG. 4). Each of the two fixing portions 703 includes a first member 704 and a second member 705, both of which are formed in a plate shape. An associated bundle of cables 11 is partially clamped between the first and second members 704 and 705.

The fixed unit 20 includes a pair of first coil units 52 and a pair of second coil units 53 to make the movable unit 10 electromagnetically drivable and rotatable (see FIG. 4). The pair of first coil units 52 allows the movable unit 10 to rotate around the axis 1b. The pair of second coil units 53 allows the movable unit 10 to rotate around the axis 1c.

The pair of first coil units 52 each include a first magnetic yoke 710 made of a magnetic material, drive coils 720 and 730, and magnetic yoke holders 740 and 750 (see FIG. 4). Each of the first magnetic yokes 710 has the shape of an arc, of which the center is defined by the center of rotation 460. The drive coils 730 are each formed by winding a conductive wire around its associated first magnetic yoke 710 such that its winding direction is defined around the axis 1b (i.e., the direction in which the second coil units 53 face each other) and that the pair of first drive magnets 620 (to be described later) is driven in rotation in the rolling direction. As used herein, the winding direction of the coil refers in this embodiment to a direction in which the number of turns increases (e.g., an axial direction in the case of a cylindrical coil). After each drive coil 730 has been formed around its associated first magnetic yoke 710, the magnetic yoke holders 740 and 750 are secured with screws onto the first magnetic yoke 710 on both sides thereof. Thereafter, the drive coils 720 are each formed by winding a conductive wire around its associated first magnetic yoke 710 such that its winding direction is defined around the optical axis 1a when the movable unit 10 is in the neutral position and that the pair of first drive magnets 620 is driven in rotation in the panning direction. Then, the pair of first coil units 52 is secured with screws onto the body 51 so as to face each other when viewed from the camera unit 3. Specifically, each of the first coil units 52 has one end thereof along the optical axis 1a secured with a screw onto the body 51. Each of the first coil units 52 has the other end thereof along the optical axis 1a fitted into the upper ring 4.

The pair of second coil units 53 each include a second magnetic yoke 711 made of a magnetic material, drive coils 721 and 731, and magnetic yoke holders 741 and 751 (see FIG. 4). Each of the second magnetic yokes 711 has the shape of an arc, of which the center is defined by the center of rotation 460. The drive coils 731 are each formed by winding a conductive wire around its associated second magnetic yoke 711 such that its winding direction is defined around the axis 1c (i.e., the direction in which the first coil units 52 face each other) and that the pair of second drive magnets 621 (to be described later) is driven in rotation in the rolling direction. After each drive coil 731 has been formed around its associated second magnetic yoke 711, the magnetic yoke holders 741 and 751 are secured with screws onto the second magnetic yoke 711 on both sides thereof. Thereafter, the drive coils 721 are each formed by winding a conductive wire around its associated second magnetic yoke 711 such that its winding direction is defined around the optical axis 1a when the movable unit 10 is in the neutral position and that the pair of second drive magnets 621 is driven in rotation in the tilting direction. Then, the pair of second coil units 53 is secured with screws onto the body 51 so as to face each other when viewed from the camera unit 3. Specifically, each of the second coil units 53 has one end thereof along the optical axis 1a secured with a screw onto the body 51. Each of the second coil units 53 has the other end thereof along the optical axis 1a fitted into the upper ring 4.

The camera holder 40 on which the camera unit 3 has been mounted is secured with screws onto the first movable base 41. The coupling member 50 is interposed between the first movable base 41 and the second movable base 42.

The printed circuit board 90 includes a plurality of (e.g., four in this embodiment) magnetic sensors 92 for detecting rotational positions in the panning and tilting directions of the camera unit 3. In this embodiment, the magnetic sensors 92 may be implemented as Hall elements, for example.

On the printed circuit board 90, further assembled are a circuit for controlling the amount of a current allowed to flow through the drive coils 720, 721, 730, and 731 and other circuits. Examples of the other circuits assembled on the printed circuit board 90 include a circuit having the capability of a driver unit 120 shown in FIG. 1 and a sensor 130 shown in FIG. 1.

A microcomputer (or microcontroller) may be built on the printed circuit board 90. The microcomputer performs the functions of a control unit 110 and a camera control unit 150 shown in FIG. 1 by executing a program stored in its memory. In this embodiment, the program may be stored in advance in the memory of the computer. Alternatively, the program may also be downloaded via a telecommunications line such as the Internet or distributed after having been stored on a storage medium such as a memory card. Note that the control unit 110 and the camera control unit 150 will be described in detail later.

Next, detailed configurations for the first movable base 41 and the second movable base 42 will be described.

The first movable base 41 includes a body 43, a pair of holding portions 44, a loosely fitting member 45, and a sphere 46 (see FIG. 5). The body 43 sandwiches a rigid portion 12 between itself and the camera holder 40 to fix (hold) the rigid portion 12 thereon. The respective holding portions 44 are provided for the peripheral edge of the body 43 so as to face each other (see FIG. 5). Each holding portion 44 clamps and holds an associated bundle of cables 11 between itself and a sidewall 431 of the body 43 (see FIG. 3). The loosely fitting member 45 has a tapered through hole 451 (see FIG. 3). The sphere 46 is fitted and fixed into the through hole 451 of the loosely fitting member 45 and has a first loosely fitting face 461 as a raised spherical surface (see FIG. 3). The first loosely fitting face 461 makes a point or line contact with a second loosely fitting face 507 of the wall 505 of the loosely fitting member 502 so as to be loosely fitted into the second loosely fitting face 507 with a narrow gap left between them. This allows the coupling member 50 to pivotally support the movable unit 10 to make the movable unit 10 rotatable. In this case, the center of mass of the sphere 46 defines the center of rotation 460.

The second movable base 42 supports the first movable base 41. The second movable base 42 includes a back yoke 610, a pair of first drive magnets 620, and a pair of second drive magnets 621 (see FIG. 5). The second movable base 42 further includes a bottom plate 640, a position detecting magnet 650, and a stopper member 651 (see FIG. 5).

The back yoke 610 includes a disk portion and four fixing portions (arms) extending from the outer periphery of the disk portion toward the camera unit 3 (i.e., upward). Two out of the four fixing portions face each other along the axis 1b, while the other two fixing portions face each other along the axis 1c. These four fixing portions correspond one to one to the pair of first coil units 52 and the pair of second coil units 53.

The pair of first drive magnets 620 are provided one to one for two fixing portions, respectively facing the pair of first coil units 52, out of the four fixing portions of the back yoke 610. The pair of second drive magnets 621 are provided one to one for two fixing portions, respectively facing the pair of second coil units 53, out of the four fixing portions of the back yoke 610.

Electromagnetic driving by the first drive magnets 620 and the first coil units 52 and electromagnetic driving by the second drive magnets 621 and the second coil units 53 allow the movable unit 10 (camera unit 3) to rotate in the panning, tilting, and rolling directions. Specifically, electromagnetic driving by the two drive coils 720 and the two first drive magnets 620 and electromagnetic driving by the two drive coils 721 and the two second drive magnets 621 allow the movable unit 10 to rotate in the panning and tilting directions. Meanwhile, electromagnetic driving by the two drive coils 730 and the two first drive magnets 620 and electromagnetic driving by the two drive coils 731 and the two second drive magnets 621 allow the movable unit 10 to rotate in the rolling direction.

The bottom plate 640 is a non-magnetic member and may be made of brass, for example. The bottom plate 640 is attached to the back yoke 610 to define the bottom of the movable unit 10 (i.e., the bottom of the second movable base 42). The bottom plate 640 is secured with screws onto the back yoke and the first movable base 41. The bottom plate 640 serves as a counterweight. Having the bottom plate 640 serve as a counterweight allows the center of rotation 460 to agree with the center of gravity of the movable unit 10. That is why when external force is applied to the entire movable unit 10, the moment of rotation of the movable unit 10 around the axis 1b and the moment of rotation of the movable unit 10 around the axis 1c both decrease. This allows the movable unit 10 (or the camera unit 3) to be held in the neutral position, or to rotate around the axes 1b and 1c, with less driving force.

One surface, located closer to the camera unit 3, of the bottom plate 640 is a flat surface, a central portion of which has a projection 641. The projection 641 has a curved recess 642 at the tip. The loosely fitting member 502 is located closer to the camera unit 3 than (i.e., arranged over) the recess 642.

The other surface, located more distant from the camera unit 3, of the bottom plate 640 is a spherical surface, a central portion of which has a recess. In the recess, arranged are the position detecting magnet 650 and the stopper member 651 (see FIG. 3). The stopper member 651 prevents the position detecting magnet 650, arranged in the recess of the bottom plate 640, from falling off.

A gap is left between the recess 642 of the bottom plate 640 and the loosely fitting member 502 (see FIG. 3). The inner peripheral surface of the recess 642 of the bottom plate 640 and the spherical surface of the base 504 of the loosely fitting member 502 are curved surfaces that face each other. This gap is wide enough to allow, even when the bottom plate 640 comes into contact with the loosely fitting member 502, the first drive magnets 620 and the second drive magnets 621 to go back to their home positions due to their own magnetism. Thus, even if the camera unit 3 has moved along the optical axis 1a while being located in the neutral position, the pair of first drive magnets 620 and the pair of second drive magnets 621 are still allowed to go back to their home positions.

As the movable unit 10 rotates, the position detecting magnet 650 changes its position, thus causing a variation in the magnetic force applied to the four magnetic sensors 92 provided for the printed circuit board 90. The four magnetic sensors 92 detect a variation, caused by the rotation of the position detecting magnet 650, in the magnetic force, and calculate two-dimensional angles of rotation with respect to the axes 1b and 1c. This allows the four magnetic sensors 92 to detect the rotational positions in the tilting and panning directions. In addition, the camera device 1 further includes, separately from the four magnetic sensors 92, another magnetic sensor for detecting the rotation of the movable unit 10 (i.e., the rotation of the camera unit 3) around the optical axis 1a. Note that the sensor for detecting the rotation around the optical axis 1a does not have to be a magnetic sensor but may also be a gyrosensor, for example.

In this case, the pair of first drive magnets 620 serves as attracting magnets, thus producing first magnetic attraction forces between the pair of first drive magnets 620 and the first magnetic yokes 710 that face the first drive magnets 620. Likewise, the pair of second drive magnets 621 also serves as attracting magnets, thus producing second magnetic attraction forces between the pair of second drive magnets 621 and the second magnetic yokes 711 that face the second drive magnets 621. The vector direction of each of the first magnetic attraction forces is parallel to a centerline that connects together the center of rotation 460, the center of mass of an associated one of the first magnetic yokes 710, and the center of mass of an associated one of the first drive magnets 620. The vector direction of each of the second magnetic attraction forces is parallel to a centerline that connects together the center of rotation 460, the center of mass of an associated one of the second magnetic yokes 711, and the center of mass of an associated one of the second drive magnets 621.

The first and second magnetic attraction forces become normal forces produced by the loosely fitting member 502 of the fixed unit 20 with respect to the sphere 46. Also, when the movable unit 10 is in the neutral position, the magnetic attraction forces of the movable unit 10 define a synthetic vector along the optical axis 1a of the camera unit 3 in the neutral position. This force balance between the first magnetic attraction forces, the second magnetic attraction forces, and the synthetic vector resembles the dynamic configuration of a balancing toy, and allows the movable unit 10 to rotate in three axis directions with good stability.

In this embodiment, the pair of first coil units 52, the pair of second coil units 53, the pair of first drive magnets 620, and the pair of second drive magnets 621 together form the driving unit 30. The driving unit 30 includes a first driving unit 30a for rotating the movable unit 10 in the tilting direction, a second driving unit 30b for rotating the movable unit 10 in the panning direction, and a third driving unit 30c for rotating the movable unit 10 in the rolling direction.

The first driving unit 30a includes the pair of first magnetic yokes 710 and pair of drive coils 720 included in the pair of first coil units 52, and the pair of first drive magnets 620. The second driving unit 30b includes the pair of second magnetic yokes 711 and pair of drive coils 721 included in the pair of second coil units 53, and the pair of second drive magnets 621. The third driving unit 30c includes the pair of first drive magnets 620, the pair of second drive magnets 621, the pair of first magnetic yokes 710, the pair of second magnetic yokes 711, the pair of drive coils 730, and the pair of drive coils 731.

The camera device 1 of this embodiment allows the movable unit 10 to rotate two-dimensionally (i.e., pan and tilt) by supplying electricity to the pair of drive coils 720 and the pair of drive coils 721 simultaneously. In addition, the camera device 1 also allows the movable unit 10 to rotate (i.e., to roll) around the optical axis 1a by supplying electricity to the pair of drive coils 730 and the pair of drive coils 731 simultaneously.

Next, a functional configuration of the camera device 1 will be described.

The camera device 1 includes a storage unit 100, a control unit 110, a driver unit 120, a communications unit 140, a camera control unit 150, the driving unit 30, and the camera unit 3 (see FIG. 1).

The sensor 130 may be a gyrosensor, for example. The sensor 130 detects the angular velocity of the printed circuit board 90 including the sensor 130, i.e., the angular velocity of the fixed unit 20. Then, the sensor 130 outputs a result of detection to the control unit 110.

The storage unit 100 is implemented as a device selected from the group consisting of a read-only memory (ROM), a random access memory (RAM), an electrically erasable programmable read-only memory (EEPROM), and other storage devices. The storage unit 100 stores a processing table showing correspondence between the number of times of taps and the processing to be performed on the camera unit 3. For example, according to the processing table, the number of times of taps “2” may correspond to the processing of “starting capturing a moving picture,” and the number of times of taps “3” may correspond to the processing of “finishing capturing a moving picture.”

The control unit 110 has the capability of controlling the drives (including the rotational drive and vibrational drive) of the movable unit 10. The function of the control unit 110 is performed by the microcomputer executing a program as described above. The control unit 110 includes a driving control unit 111 and a detection processing unit 112 as shown in FIG. 1.

The driving control unit 111 generates a rotational drive signal to drive the movable unit 10 in rotation in the tilting, panning, and rolling directions, and outputs the rotational drive signal to one of the three driver units in the driver unit 120 according to the direction in which the movable unit 10 needs to be rotated. For example, to rotate the movable unit 10 in the tilting direction, the driving control unit 111 outputs the rotational drive signal to a first driver unit 121 to be described later. Meanwhile, to rotate the movable unit 10 in the panning direction, the driving control unit 111 outputs the rotational drive signal to a second driver unit 122 to be described later. Furthermore, to rotate the movable unit 10 in the rolling direction, the driving control unit 111 outputs the rotational drive signal to a third driver unit 123 to be described later. As the rotational drive signal, either a damping drive signal or a vibrational drive signal may be used. The damping drive signal and the vibrational drive signal are signals generated by a pulse width modulation (PWM) method for changing the on-duty ratio on a cycle basis. The inverse number of one cycle of PWM may be several ten kHz, for example. The damping drive signal and the vibrational drive signal may be generated by varying the duty ratio of the PWM.

The frequency of the damping drive signal is determined to allow the camera device 1 (actuator 2) to function as a stabilizer 2a and may fall within the range from a few Hz to several ten Hz, for example. To allow the actuator 2 to serve as a stabilizer 2a, the rotational drive signal (damping drive signal) suitably has a frequency of 40-50 Hz or less.

The driving control unit 111 generates a rotational drive signal (vibrational drive signal) to drive the movable unit 10 in vibration in the rolling direction and outputs the vibrational drive signal to the third driver unit 123. In this case, if the frequency of the vibrational drive signal falls within the range from 100 Hz to 300 Hz, the user may be given a touch stimulus. On the other hand, if the frequency of the vibrational drive signal falls within the range from 1 kHz to 8 kHz, an audible sound may be generated. In this case, the audible sound may be a speech uttered by a human speaker. The audible sound does not have to be a speech but may also be a beep, a melody, or any other suitable sound.

The frequency of the vibrational drive signal is higher than the frequency of the damping drive signal. Therefore, the damping drive signal and the vibrational drive signal may be output so as to be superposed one upon the other, thus allowing the camera device 1 to serve as a stabilizer 2a and be driven in vibration during its operation. Optionally, either the damping drive signal or the vibrational drive signal may be output as the rotational drive signal.

This configuration allows the driving control unit 111 to output the vibrational drive signal to the third driver unit 123. A current, of which the amount is controlled by the vibrational drive signal, flows through the pair of drive coils 730 and pair of drive coils 731 of the third driving unit 30c, thus allowing the movable unit 10 to be driven in vibration in the rolling direction in synch with the vibrational drive signal. This vibration produces an audible sound. Alternatively, when putting a finger on the actuator 2, the user is given a touch stimulus. Also, the more significantly the duty of the PWM varies, the larger the amplitude of vibration produced by the movable unit 10 becomes. That is why the duty is suitably allowed to vary more significantly as the amplitude of the vibrational drive signal increases.

As the movable unit 10 is driven in vibration under the control of the driving control unit 111, the fixed unit 20 also vibrates in synch with the vibration of the movable unit 10. That is to say, the vibrational drive of the movable unit 10 triggers the vibration of the entire camera device 1.

The detection processing unit 112 controls the driving control unit 111 based on the result of detection by the sensor 130 so as to generate a rotational drive signal corresponding to the result of detection.

The detection processing unit 112 determines whether or not the result of detection (angular velocity) obtained by the sensor 130 is a result of a tap operation performed by the user or a result produced due to any other factor. For example, the detection processing unit 112 may determine, based on the ratio of the respective magnitudes of vectors detected by the sensor 130 in the three axis directions and depending on whether the resultant force of the vectors in the three axis directions falls within a predetermined range, whether or not any tap operation has been performed.

When determining that the sensor 130 should have detected the angular velocity produced by the user's tap operation, the detection processing unit 112 obtains how many times the angular velocity has been detected during a predetermined period (of 3 seconds, for example), i.e., the number of times of taps. The detection processing unit 112 determines, by reference to the processing table in the storage unit 100, what type of processing should be performed in accordance with the number of times of taps obtained. Then, the detection processing unit 112 outputs an instruction signal indicating the type of the processing thus determined to the camera control unit 150. The detection processing unit 112 controls the driving control unit 111 such that the driving control unit 111 performs vibrational drive in response to (i.e., to answer back) the user's tap operation.

On the other hand, when determining that the sensor 130 should have detected the angular velocity produced due to any other factor (such as the user's hand tremors), not by the user's tap operation, the detection processing unit 112 makes correction to the positional displacement, caused by the hand tremors, for example, of the camera device 1 based on the angular velocity and the result of detection by the magnetic sensors 92. Specifically, the detection processing unit 112 obtains, based on the respective results of detection by the sensor 130 and the magnetic sensors 92, the rotational angle in at least one of the three rotational directions. Then, the detection processing unit 112 controls the driving control unit 111 such that the driving control unit 111 drives the movable unit 10 in rotation by the rotational angle thus obtained. This allows the camera device 1 to serve as a stabilizer 2a.

In this camera device 1, the sensor 130 and the detection processing unit 112 together function as a detection unit 160 for detecting a predetermined type of operation (such as a tap operation) performed by the user on the fixed unit 20.

The driver unit 120 includes the first driver unit 121, the second driver unit 122, and the third driver unit 123. The first driver unit 121 controls output of the rotational drive signal (damping drive signal) to the first driving unit 30a. The second driver unit 122 controls output of the rotational drive signal (damping drive signal) to the second driving unit 30b. The third driver unit 123 controls output of the vibrational drive signal and the damping drive signal to the third driving unit 30c.

The communications unit 140 communicates wirelessly with the telecommunications device 8 (see FIG. 1). The communication between the communications unit 140 and the telecommunications device 8 may be either Wi-Fi® or a wireless communication compliant with a low power radio standard (such as the Specific Low Power Radio standard) that requires no licenses, for example. As for this type of low power radio, the frequency band, antenna power, and other specific parameters to be adopted according to the intended use are defined in respective countries. In Japan, for example, a low power radio standard that requires the use of radio waves on the 920 MHz band or the 420 MHz band is defined.

The camera control unit 150 performs, in response to the signal received from the detection processing unit 112, processing on an image signal (output signal) of the image sensor 3a, i.e., processing concerning moving picture capturing by the camera unit 3. For example, if the instruction signal received from the detection processing unit 112 indicates that a moving picture should start to be captured, the camera control unit 150 performs the processing to start capturing a moving picture and controls the camera unit 3 to make the camera unit 3 capture a moving picture. On the other hand, if the instruction signal received from the detection processing unit 112 indicates that a moving picture should finish being captured, the camera control unit 150 performs the processing to finish capturing a moving picture and controls the camera unit 3 to make the camera unit 3 finish (or stop) capturing a moving picture.

The camera control unit 150 controls the processing related to the camera unit's 3 moving picture capturing in accordance with the signal received from the telecommunications device 8. When receiving a tap detection signal, indicating the number of times of taps, from the telecommunications device 8 via the communications unit 140, the camera control unit 150 performs processing according to the number of times of taps indicated by the tap detection signal. For example, when receiving a tap detection signal, indicating that the number of times of taps is twice, from the telecommunications device 8, the camera control unit 150 determines corresponding processing (that is processing of capturing a moving picture in this example) to perform by reference to a processing table. The camera control unit 150 carries out the processing thus determined to perform. The camera control unit 150 transmits, as a signal responsive to the tap detection signal received from the telecommunications device 8, a vibration instruction signal, instructing the telecommunications device 8 to vibrate, to the telecommunications device 8.

Next, a functional configuration of the telecommunications device 8 will be described.

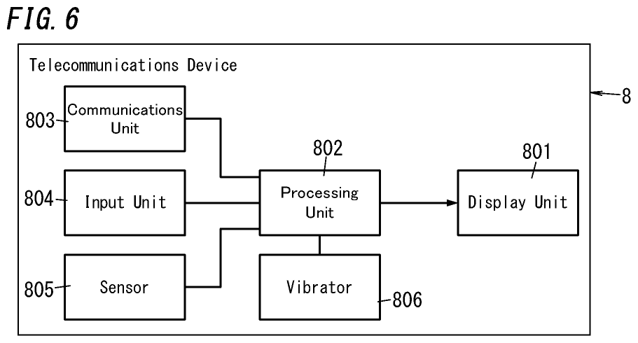

The telecommunications device 8 may be, for example, a smartphone with a display unit 801. The telecommunications device 8 includes the display unit 801, a processing unit 802, a communications unit 803, an input unit 804, a sensor 805, and a vibrator 806 as shown in FIG. 6. The telecommunications device 8 includes a central processing unit (CPU) and a memory. In other words, a computer may perform the function of the processing unit 802 by making the CPU execute a program stored in its memory. In this embodiment, the program may be downloaded via a telecommunications line such as the Internet or distributed after having been stored on a storage medium such as a memory card. Alternatively, the program may also be stored in advance in the memory of the computer.

The sensor 805 may be implemented as a gyrosensor, for example. The sensor 805 detects the angular velocity of the telecommunications device 8. The sensor 805 outputs the result of detection to the processing unit 802.

The display unit 801 may be a thin display device such as a liquid crystal display (LCD) or an organic electroluminescent (OEL) display.

The processing unit 802 controls the overall functions of the telecommunications device 8.

The processing unit 802 determines whether or not the result of detection (angular velocity) obtained by the sensor 805 is a result of a tap operation performed by the user or a result produced due to any other factor. When finding that the sensor 805 should have detected an angular velocity produced by the user's tap operation, the processing unit 802 obtains how many times the angular velocity has been detected (i.e., the number of times of taps) during a predetermined period of time (of three seconds, for example). The processing unit 802 transmits a tap detection signal, indicating the number of times of taps obtained, to the camera device 1 via the communications unit 803. As used herein, the “tap operation” on the telecommunications device 8 refers to the operation of lightly tapping the housing of the telecommunications device 8.

On receiving a vibration instruction signal from the camera device 1 via the communications unit 803, the processing unit 802 controls the vibrator 806 to make the vibrator 806 vibrate.

The communications unit 803 communicates wirelessly with the camera device 1.

The input unit 804 has the capability of accepting the operating command entered by the owner of the telecommunications device 8. In this embodiment, the telecommunications device 8 is implemented as a smartphone with a touchscreen panel display. The touchscreen panel display serves as the display unit 801 and the input unit 804.

The vibrator 806 vibrates under the control of the processing unit 802, thus vibrating the telecommunications device 8.

Next, it will be described how the camera device 1 operates.

First, it will be described how the camera device 1 operates when subjected to a tap operation by the user.

The detection processing unit 112 of the control unit 110 obtains, based on the result of detection by the sensor 130, the number of times of taps during a predetermined period. Then, the detection processing unit 112 determines, by reference to a processing table, what type of processing to perform according to the number of times of taps obtained.

The detection processing unit 112 controls the driving control unit 111 to make the driving control unit 111 drive the movable unit 10 in vibration in the rolling direction in order to answer back the tap operation. The driving control unit 111 outputs a vibration drive signal to the third driver unit 123 to drive the movable unit 10 in vibration in the rolling direction.

After having driven the movable unit 10 in vibration in the rolling direction for a predetermined amount of time (of two seconds, for example), the detection processing unit 112 outputs an instruction signal, specifying the type of processing determined to perform, to the camera control unit 150.

The camera control unit 150 performs the specified type of processing in accordance with the instruction signal received from the detection processing unit 112.

Next, it will be described how the camera device 1 operates when the user performs a tap operation on the telecommunications device 8.

The processing unit 802 of the telecommunications device 8 obtains, based on the result of detection by the sensor 805, the number of times of taps within a predetermined period. Then, the processing unit 802 transmits a tap detection signal, indicating the number of times of taps thus obtained, to the camera device 1.

The camera control unit 150 determines, by reference to a processing table, what type of processing to perform according to the number of times of taps indicated by the tap detection signal received from the telecommunications device 8. The camera control unit 150 performs the type of processing thus determined.

The camera control unit 150 transmits a vibration instruction signal to the telecommunications device 8 to answer back the tap detection signal. At this time, on receiving the vibration instruction signal from the camera device 1, the processing unit 802 of the telecommunications device 8 makes the vibrator 806 vibrate.

Note that the moving picture (image) captured by the camera unit 3 may be displayed on either a display unit provided for the camera device 1 or the display unit 801 of the telecommunications device 8. Alternatively, the image captured by the camera unit 3 may also be stored in the storage unit 100.

(Variations)

Next, variations will be enumerated one after another. Note that any of the variations to be described below may be combined as appropriate with the embodiment described above.

In the embodiment described above, the sensor 130 is provided for the printed circuit board 90. However, this configuration is only an example and should not be construed as limiting. Alternatively, the sensor 130 may also be provided for somewhere else in the fixed unit 20, instead of the printed circuit board 90. Still alternatively, the sensor 130 may also be provided for the movable unit 10, in place of the fixed unit 20.

Also, in the embodiment described above, the sensor 130 may be a gyrosensor, for example. However, this is only an example and should not be construed as limiting. Alternatively, the sensor 130 may be a triaxial acceleration sensor as well.

Furthermore, in the embodiment described above, the driving control unit 111 is configured to drive the movable unit 10 in vibration in the rolling direction. However, this configuration is only an example and should not be construed as limiting. Alternatively, the driving control unit 111 may drive the movable unit 10 in vibration in the panning direction or the tilting direction as well.

Furthermore, in the embodiment described above, the movable unit 10 of the camera device 1 is configured to be rotatable in the three axis directions (namely, the panning direction, the tilting direction, and the rolling direction). However, this configuration is only an example and should not be construed as limiting. The movable unit 10 of the camera device 1 only needs to be rotatable in at least two of the three axis directions.

Furthermore, in the embodiment described above, when receiving a tap detection signal from the telecommunications device 8, the camera device 1 transmits a vibration instruction signal to the telecommunications device 8 to answer back the tap detection signal. However, this is only an example and should not be construed as limiting. Alternatively, to answer back the tap detection signal, the camera device 1 may drive the movable unit 10 in vibration. In that case, in a situation where the user is wearing the camera device 1, the vibration of the movable unit 10 allows him or her to sense that his or her command has certainly been accepted by the camera unit 3 as a result of the tap operation performed by him or her on the telecommunications device 8.

Still alternatively, to answer back the tap detection signal, the camera device 1 may not only transmit the vibration instruction signal to the telecommunications device 8 but also drive the movable unit 10 in vibration as well. That is to say, the camera device 1 may vibrate both of the movable unit 10 and the telecommunications device 8.

Even though the camera device 1 according to the embodiment described above includes the magnetic sensors 92, the magnetic sensors 92 are not essential constituent elements. When provided with no magnetic sensors 92, the camera device 1 may obtain, based on the result of detection by the sensor 130, an angle of rotation for making correction to the displacement of the camera unit 3.

Furthermore, in the embodiment described above, the detection processing unit 112 of the camera device 1 is configured to detect the number of times of taps. However, this is only an example and should not be construed as limiting. Alternatively, the detection processing unit 112 may also detect a shake of the camera device 1. That is to say, the detection processing unit 112 may detect application of external force to the camera device 1. For example, if the result of detection (angular velocity) by the sensor 130 varies frequently and significantly, then the detection processing unit 112 determines that the camera device 1 should be being shaken.

Also, in the embodiment described above, the telecommunications device 8 is configured to transmit a tap detection signal, indicating the number of times of taps, to the camera device 1. However, this is only an example and should not be construed as limiting. Alternatively, the telecommunications device 8 may also transmit a camera control signal indicating the type of processing to perform according to the number of times of taps to the camera device 1. In that case, the telecommunications device 8 stores, in a predetermined storage area, the same table as the processing table stored in the storage unit 100 of the camera device 1. The processing unit 802 of the telecommunications device 8 determines the type of processing to perform according to the number of times of taps by reference to the table stored in the storage area. Then, the processing unit 802 transmits a camera control signal indicating the type of processing thus determined to the camera device 1. On receiving, from the telecommunications device 8, the camera control signal specifying the type of processing to perform determined by the telecommunications device 8, the camera control unit 150 performs the type of processing specified by the camera control signal received.

Furthermore, in the embodiment described above, the camera device 1 is configured to emit an audible sound when driving the movable unit 10 in vibration. However, this is only an example and should not be construed as limiting. Rather the camera device 1 needs to vibrate the movable unit 10 to say the least. That is to say, the frequency of the vibration drive signal does not have to be higher than the frequency of the damping drive signal but may also fall within a range from a few Hz to several ten Hz, which overlaps with the frequency range of the damping drive signal.

Furthermore, in the embodiment described above, when a tap operation is performed on the camera device 1, the vibrational drive is performed to answer back the tap operation before control is performed by the camera control unit 150. However, this is only an example and should not be construed as limiting. Alternatively, when a tap operation is performed on the camera device 1, the vibrational drive may be performed to answer back the tap operation after the control has been performed by the camera control unit 150.

Still alternatively, when a tap operation is performed on the camera device 1, the timing to answer back the tap operation may be changed according to the type of control to be performed by the camera control unit 150. For example, if the type of control to be performed by the camera control unit 150 is to start capturing a moving picture, then the detection processing unit 112 performs the vibrational drive to answer back the tap operation before the control is performed by the camera control unit 150. On the other hand, if the control to be performed by the camera control unit 150 is to finish capturing a moving picture, then the detection processing unit 112 performs the vibrational drive to answer back the tap operation after the control has been performed by the camera control unit 150. This prevents the image captured by the camera unit 3 from being blurred by the vibrational drive.

In the embodiment described above, the optical device is implemented as the camera device 1. However, the optical device does not have to be the camera device 1. An optical device according to the present disclosure is also applicable to any other device including some optical element such as a photosensitive element, a light-emitting element, or the image sensor 3a. Examples of alternative optical devices include a laser pointer, a light fixture, and a projector. When applied to a laser pointer, a light fixture, a projector, or any other type of device, the optical device includes an element control unit in place of the camera control unit 150. In that case, in response to the user's tap operation on either the optical device or the telecommunications device 8, the element control unit controls output of light (or output signal) from the optical element (such as a light-emitting element).

Also, in the embodiment described above, the sphere 46 is configured to be fitted and fixed into the through hole 451 of the loosely fitting member 45. However, this configuration is only an example and should not be construed as limiting. Alternatively, the sphere 46 may also be configured to be fixed into the recess 506 of the loosely fitting member 502. In that case, an inner peripheral surface of the through hole 451 of the loosely fitting member 45 corresponds to the first loosely fitting face and the raised spherical surface of the sphere 46 protruding from the loosely fitting member 502 corresponds to the second loosely fitting face. The raised spherical surface (second loosely fitting face) of the sphere 46 protruding from the loosely fitting member 502 makes a point or line contact with the inner peripheral surface (first loosely fitting face) of the through hole 451 of the loosely fitting member 45 so as to be loosely fitted into the first loosely fitting face with a narrow gap left between them.

Furthermore, in the embodiment described above, in response to a tap operation performed by the user on either the camera device 1 or the telecommunications device 8, the camera device 1 performs processing to start or finish capturing a moving picture with the camera unit 3. However, this is only an example and should not be construed as limiting. Alternatively, when a tap operation is performed by the user on either the camera device 1 or the telecommunications device 8, the camera device 1 may also perform processing to capture a still image. Still alternatively, when a tap operation is performed by the user on either the camera device 1 or the telecommunications device 8, the camera device 1 may also perform processing to start or finish supplying power to the camera unit 3, i.e., processing to activate or deactivate the camera unit 3.

(Resume)

As can be seen from the foregoing description, an optical device (camera device 1) according to a first aspect includes an optical unit (camera unit 3), a movable unit (10), a fixed unit (20), a driving unit (30), a driving control unit (111), and a detection unit (160). The optical unit includes an optical element (image sensor 3a). The movable unit (10) holds the optical unit thereon. The fixed unit (20) supports the movable unit (10) so as to make the movable unit (10) rotatable in at least two directions selected from the group consisting of a panning direction, a tilting direction, and a rolling direction. The driving unit (30) drives the movable unit (10) in rotation in the at least two directions with respect to the fixed unit (20). The driving control unit (111) controls the driving unit (30) to rotate the movable unit (10). The detection unit (160) detects a predetermined type of operation (such as a tap operation) performed by a user on at least one of the fixed unit (20) or the movable unit (10). The driving control unit (111) controls, when the detection unit (160) detects the predetermined type of operation performed by the user, the driving unit (30) such that the movable unit (10) produces vibrations in at least one direction out of the at least two directions.

According to this configuration, on detecting a predetermined type of operation performed by the user, the optical device produces vibrations in the movable unit (10). This allows the user to feel the vibration produced by the movable unit (10) and thereby learn, even while the user is wearing the optical device, that his or her command has been accepted by the optical device. In other words, this allows the optical device to notify, even while the user is wearing the optical device, the user that the optical device has certainly accepted his or her command.

In an optical device according to a second aspect, which may be implemented in conjunction with the first aspect, the driving control unit (111) controls the driving unit (30) such that the movable unit (10) produces vibrations at an audible frequency in the at least one direction. This configuration allows the user to learn, by an audible sound as well, that his or her command has been accepted by the optical device.

An optical device according to a third aspect, which may be implemented in conjunction with the first or second aspect, is used as a stabilizer (2a) to drive the movable unit (10) in a desired rotational direction out of the at least two directions. The driving control unit drives the movable unit (10) in rotation in the desired rotational direction and outputs a rotational drive signal, including at least one of a vibrational drive signal or a damping drive signal, to the driving unit (30). The vibrational drive signal is applied to allow the movable unit (10) to produce vibrations. The damping drive signal is applied to damp the vibrations of the movable unit (10). This configuration allows the optical device to reduce unnecessary vibrations of the optical unit (such as the camera unit 3) while driving the movable unit (10) in rotation.

In an optical device according to a fourth aspect, which may be implemented in conjunction with the third aspect, the vibrational drive signal has a higher frequency than the damping drive signal. This configuration allows the damping drive signal and the vibrational drive signal to be easily distinguished from each other.

In an optical device according to a fifth aspect, which may be implemented in conjunction with the third or fourth aspect, the detection unit (160) includes a gyrosensor (sensor 130). The gyro sensor detects at least one of an angular velocity of the fixed unit (20) or an angular velocity of the movable unit (10). The driving control unit (111) controls the driving unit (30) based on the angular velocity detected by the gyrosensor so as to allow the optical device to serve as the stabilizer (2a). This configuration allows the optical device to use the gyrosensor to detect the predetermined type of operation performed by the user and to make the optical device serve as a stabilizer (2a).

In an optical device according to a sixth aspect, which may be implemented in conjunction with any one of the first to fifth aspects, the driving unit (30) includes: a pair of drive magnets (first drive magnets 620 and second drive magnets 621) provided for the movable unit (10); and a pair of coils (drive coils 720, 730, 721, and 731). The pair of coils are provided for the fixed unit (20) so as to respectively face the pair of drive magnets. The driving unit (30) electromagnetically drives the movable unit (10) using the pair of coils and the pair of drive magnets. This configuration allows the optical device to electromagnetically drive the movable unit (10) in rotation.

An optical device according to a seventh aspect, which may be implemented in conjunction with any one of the first to sixth aspects, further includes a communications unit (140) and a processing control unit (camera control unit 150). The communications unit (140) receives, from a telecommunications device (8), a signal (such as a tap detection signal) generated by a predetermined type of operation performed by the user on the telecommunications device (8). The processing control unit processes or controls an output signal of the optical element of the optical unit in accordance with the signal received by the communications unit (140). This configuration allows the optical device to perform processing in accordance with an instruction from an external device (such as the telecommunications device 8). This allows the user to enter his or her operating command into the optical device by using his or her own telecommunications device (8) instead of directly operating the optical device.

In an optical device according to an eighth aspect, which may be implemented in conjunction with the seventh aspect, the predetermined type of operation performed by the user on at least one of the fixed unit (20) or the movable unit (10) is a first tap operation. The predetermined type of operation performed by the user on the telecommunications device (8) is a second tap operation. The processing control unit performs, when the first tap operation is performed as many times as the second tap operation, the same processing on the optical unit. This configuration eliminates the need for the user to sense the difference in operation to perform because to perform the same processing, the optical device and the telecommunications device (8) may be operated in quite the same way.

In an optical device according to a ninth aspect, which may be implemented in conjunction with the seventh or eighth aspect, the communications unit (140) transmits a vibration instruction signal to the telecommunications device (8) to make the telecommunications device (8) vibrate on receiving the signal. This configuration makes the telecommunications device (8) vibrate, and allows the user to learn, by the vibrations of the telecommunications device (8) as well, that his or her command has been accepted.

In an optical device according to a tenth aspect, which may be implemented in conjunction with any one of the first to ninth aspects, the optical element is an image sensor (3a). This configuration allows the optical device to perform shooting-related processing in response to a predetermined type of operation performed by the user.

1. An optical device comprising:
an optical unit including an optical element;
a movable unit configured to hold the optical unit thereon;
a fixed unit configured to support the movable unit so as to make the movable unit rotatable in at least two directions selected from the group consisting of a panning direction, a tilting direction, and a rolling direction;
a driving unit configured to drive the movable unit in rotation in the at least two directions with respect to the fixed unit;
a driving control unit configured to control the driving unit to rotate the movable unit; and
a detection unit configured to detect a predetermined type of operation performed by a user on at least one of the fixed unit or the movable unit,
the driving control unit being configured to, when the detection unit detects the predetermined type of operation performed by the user, control the driving unit such that the movable unit produces vibrations in at least one direction out of the at least two directions.

2. The optical device of claim 1, wherein
the driving control unit is configured to control the driving unit such that the movable unit produces vibrations at an audible frequency in the at least one direction.

3. The optical device of claim 1, wherein
the optical device is designed to be used as a stabilizer configured to drive the movable unit in a desired rotational direction out of the at least two directions, and
the driving control unit is configured to drive the movable unit in rotation in the desired rotational direction and output a rotational drive signal, including at least one of a vibrational drive signal or a damping drive signal, to the driving unit, the vibrational drive signal being applied to allow the movable unit to produce vibrations, the damping drive signal being applied to damp the vibrations of the movable unit.

4. The optical device of claim 3, wherein
the vibrational drive signal has a higher frequency than the damping drive signal.

5. The optical device of claim 3, wherein
the detection unit includes a gyrosensor,
the gyrosensor is configured to detect at least one of an angular velocity of the fixed unit or an angular velocity of the movable unit, and
the driving control unit is configured to control the driving unit based on the angular velocity detected by the gyrosensor so as to allow the optical device to serve as the stabilizer.

6. The optical device of claim 1, wherein
the driving unit includes: a pair of drive magnets provided for the movable unit; and a pair of coils provided for the fixed unit so as to respectively face the pair of drive magnets, and
the driving unit is configured to electromagnetically drive the movable unit using the pair of coils and the pair of drive magnets.

7. The optical device of claim 1, further comprising:
a communications unit configured to receive, from a telecommunications device, a signal generated by a predetermined type of operation performed by the user on the telecommunications device; and
a processing control unit configured to process or control an output signal of the optical element of the optical unit in accordance with the signal received by the communications unit.

8. The optical device of claim 7, wherein
the predetermined type of operation performed by the user on at least one of the fixed unit or the movable unit is a first tap operation;
the predetermined type of operation performed by the user on the telecommunications device is a second tap operation; and
the processing control unit is configured to, when the first tap operation is performed as many times as the second tap operation, perform the same processing on the optical unit.

9. The optical device of claim 7, wherein
the communications unit is configured to transmit a vibration instruction signal to the telecommunications device to make the telecommunications device vibrate on receiving the signal.

10. The optical device of claim 1, wherein
the optical element is an image sensor.
